(19) United States
(12) Patent Application Publication
(10) Pub. No.: US 2007/0141314 A1
(43) Pub. Date: Jun. 21, 2007

(54) Evaporation barrier

(76) Inventors: Bill J. Everett, Fort Stockton, TX (US); Harry L. Hammond, Fort Stockton, TX (US)

Correspondence Address: WOOD AND EISENBERG, PLLC, 6911 RICHMOND HIGHWAY, SUITE 403, Alexandria, VA, 22306, US

(21) Appl. No.: 11/304,568

(22) Filed: Dec. 16, 2005

(51) Int. Cl. B32B 7/02

(52) U.S. Cl. 428/216

(57) ABSTRACT

An evaporation barrier having a water resistant bottom layer and a UV resistant top layer. The bottom layer includes first and second opposite ends, and first and second opposite edges. The top layer overlaps at least part of at least one edge of the bottom layer. In one non-limiting embodiment, the evaporation barrier includes a plurality of generally elongated sheets arranged in adjacent rows. At least one sheet includes a water resistant bottom layer and a UV resistant top layer. The bottom layer includes opposite ends and first and second opposite edges. The UV resistant top layer overlaps at least part of one edge of the bottom layer thereby defining an elongated overlap section of the UV resistant top layer, wherein the overlap section is fastened to the top layer of an adjacent sheet.

### CROSS-REFERENCE TO RELATED APPLICATIONS

Not Applicable.

### STATEMENT REGARDING FEDERALLY SPONSORED RESEARCH OR DEVELOPMENT

Not Applicable.

### FIELD OF THE INVENTION

The present invention relates generally to evaporation barriers. More specifically, the invention is an evaporation barrier that is used to cover a body of water or other liquid.

### BACKGROUND OF THE INVENTION

Water sources are increasingly scarce. Hot arid weather has frequented large areas in, for example, southwestern United States. Cattle farmers and ranchers operating in arid conditions often need to keep water stored in large containers or reservoirs for watering livestock and need to protect such water stocks. Likewise outdoor swimming pool owners and operators need to conserve water to minimize costs.

Water can be lost in a number of ways, for example, through evaporation or contamination. Evaporation leads to a relative increase in total dissolved solids (TDS), which in turn can favor algae growth. Sunlight egress into a container holding water can cause biomass growth particularly if the TDS level is elevated due to excessive evaporation. Small animals such as birds or rodents can fall into a container holding water and drown therein leading to serious water contamination issues that can render the water unfit for human or livestock consumption.

Though often ignored, rainwater can pose problems with respect to covers or evaporation barriers deployed over bodies of water. Absent an effective drainage system to channel away rainwater, heavy rain can cause evaporation barriers or covers to sink into the body of water thus negating their usefulness as a barrier to evaporation and sunlight.

Thus, there is a need for an evaporation barrier or cover to conserve water which functions by limiting the impact of incident sunlight, by preventing excessive evaporation and contamination, and can handle chronic exposure to ultraviolet (UV) radiation typically present in arid areas such as, but not limited to, parts of the southwestern United States, e.g., ranches located in dry parts of Texas.

A review of the prior art follows.

U.S. Patent Publication Number 20030222016 published Dec. 4, 2003 to Svirklys et al., describes permeable water reservoir covers including floatation panels. The Svirklys et al. covers are described as exhibiting an advantageous balance of rainwater drainage and light transmittance properties. The covers comprise a plurality of polymeric foam particles arranged in a piled laminate structure. The piled laminate structure further defines a first face and an opposing second face. At least a portion of the polymeric foam particles are bonded to at least one adjoining foam particle positioned either above or below the foam particle. The foam particles are arranged within the piled laminate structure so as to define interstices between at least some of the foam particles. The interstices are of sufficient size and quantity to allow rainwater to flow through while providing a light transmittance of less than about 95%. The Svirklys et al. apparatus offers an expensive and complex solution to the problem of water drainage.

U.S. Pat. No. 5,188,550 issued Feb. 23, 1993 to Oliver, describes a buoyant device or body for use with a plurality of similarly formed buoyant devices to produce a floating barrier. The improvement in the Oliver buoyant device comprises a relatively rigid body converging from the sides thereof to form an apex; weight means are positioned proximate the apex forming ballast; and polygonal side walls intersecting along common edges which remain engaged around the periphery of the buoyant body during relative vertical displacements. To operate properly, each Oliver buoyant device requires a weight means and vertical sides that cooperate to enable the Oliver buoyant devices to aggregate. According to the '550 patent, it is essential that the vertical sides of each Oliver buoyant device is designed with tolerances such that each Oliver buoyant device can engage with neighboring Oliver buoyant devices without leaving gaps. In addition, the Oliver buoyant devices are somewhat complex in structure and use.

U.S. Pat. No. 5,860,413 issued Jan. 19, 1999 to Bussey, Jr., et al., describes a pool cover made of multi-layer light weight construction having a transparent top layer to permit sunlight to pass through and an opaque bottom layer for absorbing sunlight passing through the transparent layer. The opaque layer includes a series of air pockets to conduct heat to the body of water in the pool while also acting as a thermal insulation barrier during non-daylight hours.

U.S. Pat. No. 3,872,522 issued Mar. 25, 1975 to Bennett et al., describes a protective cover for pools of liquid such as swimming pools. The '522 cover consists of a series of separate panels each of a size and material such that the panel will have a predetermined buoyancy factor, and reduce water absorption and wind displacement.

Allen R. Dedrick, an agricultural engineer who worked for the U.S. Water Conservation Laboratory, described foam rubber covers for controlling water storage tank evaporation (Foam Rubber Covers For Controlling Water Storage Tank Evaporation, published by the College of Agriculture, Cooperative Extension Service, Miscellaneous Report #2, University of Arizona, and Allen R. Dedrick et al., Floating Sheets of Foam Rubber for Reducing Stock Tank Evaporation, Journal of Range Management, 26(6), November 1972, pp. 404-406); both the Dedrick and Dedrick et al. references are incorporated herein by reference in their entirety. The Dedrick foam rubber covers are made of closed cell foam rubber lap-jointed sheets of 3/16^{th} inch thickness and 48 inch wide. The Dedrick foam rubber covers proved useful in reducing water evaporation, but are susceptible to damage from ultraviolet radiation found in natural sunlight. In addition, the Dedrick covers rely on lap-jointing using adhesive such as contact cement that should only be applied when the temperature is between 55° and 85° F.; as Dedrick noted, “If it's too cold, the contact cement won't get tacky fast enough; it it's too hot, it will set up too fast”. Thus, there is a need for water covers that are both resistant to ultraviolet radiation and which do not rely on temperature sensitive adhesives for lap jointing of the foam rubber sheets.

The Applicant is unaware of inventions or patents, taken either singly or in combination, which are seen to describe the instant invention as claimed.

### SUMMARY OF THE INVENTION

The present invention is an evaporation barrier designed to cover a body of fluid or liquid such as, but not limited to, a body of water. More specifically, the invention is an evaporation barrier designed to cover bodies of fluids such as water found in, for example, swimming pools, outside water tanks or reservoirs, and artificial livestock water reservoirs or tanks.

The evaporation barrier of the present invention prevents sunlight, heat, and wind from contacting the water or fluid surface. The barrier helps prevent algae and moss growth by eliminating sunlight essential for photosynthesis and keeps most atmospheric precipitated particulates out of the water or fluid. Additionally, the barrier stops birds and small animals from getting into the reservoir and drowning. The barrier has the added benefit of being buoyant, which allows it to float atop the fluid or water.

In one non-limiting embodiment, the evaporation barrier comprises an evaporation barrier sheet. The evaporation barrier sheet includes a water resistant bottom layer and a UV resistant top layer. The bottom layer includes first and second opposite ends, and first and second opposite edges. The top layer overlaps at least part of at least one edge of the bottom layer.

In another non-limiting embodiment, the invention is directed to an evaporation barrier having a plurality of generally elongated sheets arranged in adjacent rows. At least one sheet comprises a water resistant bottom layer and a UV resistant top layer. The bottom layer includes opposite ends and first and second opposite edges. The UV resistant top layer overlaps at least part of one edge of the bottom layer thereby defining an elongated overlap section of the UV resistant top layer. The overlap section is fastened to the top layer of an adjacent sheet.

### BRIEF DESCRIPTION OF DRAWINGS

FIG. 1A is an environmental, perspective view of an evaporation barrier according to the present invention.

FIG. 1B is a cross-section view of an evaporation barrier floating on a body of fluid or liquid according to the present invention.

FIG. 1C is a cross-section view of an evaporation barrier according to one aspect of the present invention.

FIG. 2A is an end view of a prior art sheet section that can be used in combination with the evaporation barrier of the present invention.

FIG. 2B is an end view of a sheet section used in another embodiment of the present invention.

FIG. 2C is an end view of a sheet section used in still another embodiment of the present invention.

FIG. 2D is an end view of a sheet section used in a further embodiment of the present invention.

FIG. 3A is a bottom view of the sheet section of FIG. 2A.

FIG. 3B is a bottom view of the sheet section of FIG. 2B.

FIG. 3C is a bottom view of the sheet section of FIG. 2C.

FIG. 3D is a bottom view of the sheet section of FIG. 2D.

FIG. 4A is a top view of an untrimmed, assembled evaporation barrier according to the present invention.

FIG. 4B is a top view of the evaporation barrier of FIG. 4A after trimming.

FIG. 4C is a top view of an evaporation barrier with optional apertures that function as bailing holes according to the present invention.

FIG. 5 shows a fragmentary cross-section view of an evaporation barrier with a third layer according to the present invention.

Similar reference characters denote corresponding features consistently throughout the attached drawings.

### DETAILED DESCRIPTION OF THE PRESENT INVENTION

The present invention is directed to evaporation barriers. More specifically, the invention is an evaporation barrier that is used to cover a body of water or other liquid.

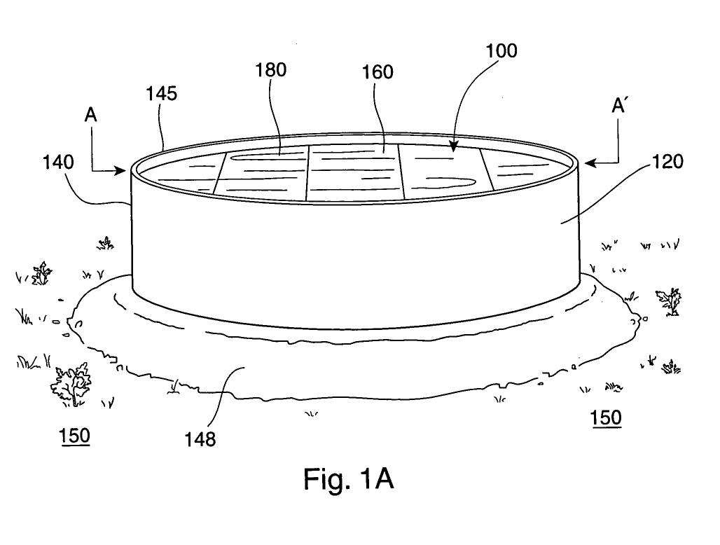

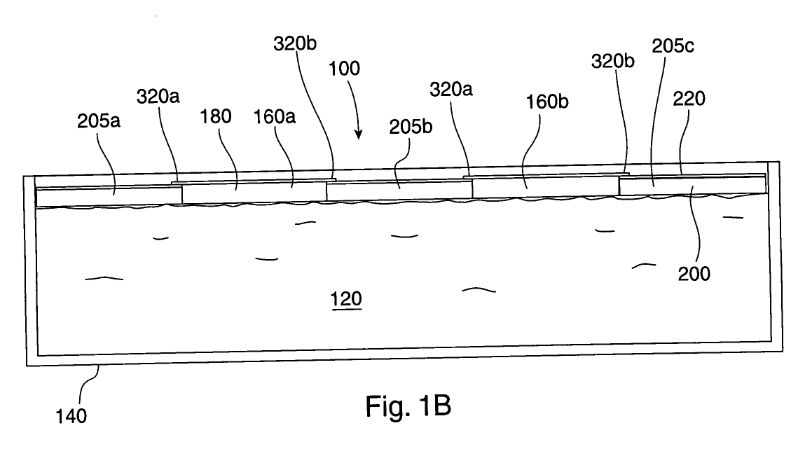

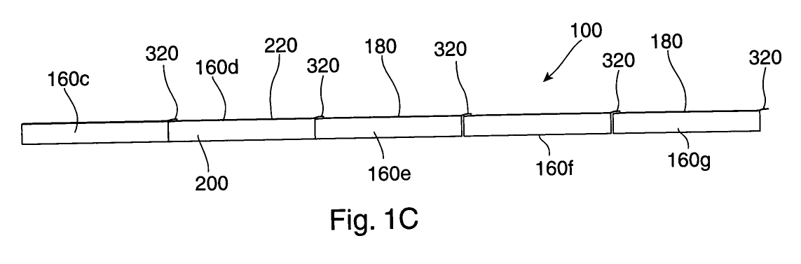

FIG. 1A shows an evaporation barrier of the present invention, which is denoted generally by the reference numeral 100. The evaporation barrier 100 is shown floating on a body of water 120 (shown, for example, in FIG. 1B) located in an otherwise open top water tank 140 atop a base 148 located in an open area 150.

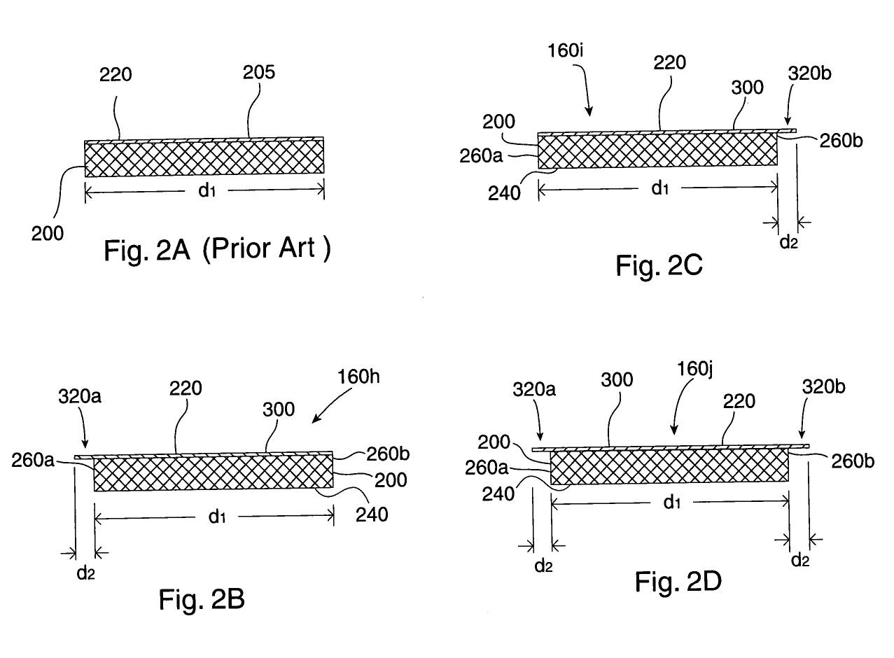

The evaporation barrier 100 comprises a plurality of generally elongated sheets 160. The sheets 160 are arranged in rows 180 such that at least one sheet 160 (see, e.g., FIGS. 1B through 1C) comprises a water resistant bottom layer 200 and an ultraviolet light (UV) resistant top layer 220, wherein at least part of the top layer 220 overlaps at least part of the bottom layer 200 thereby defining an overlap section 320 (see, e.g., FIGS. 2B through 2D).

The bottom layer 200 is secured directly to the top layer 220 in any suitable fashion. For example, the bottom layer 200 may be bonded to the top layer 220. The terms “top layer” and “UV cap” are regarded herein as equivalent terms.

The top layer 220 can be made of any suitable ultraviolet resistant material such as, but not limited to, a polyolefin layer with UV inhibitors, an ultraviolet resistant polyethylene layer, etc. The top layer 220 serves to provide additional UV protection to the bottom layer 200 from ultraviolet rays which can otherwise attack and destroy the bottom layer 200. This is believed to be a problem with respect to covers described in an article published to Dedrick et al., Floating Sheets of Foam Rubber for Reducing Stock Tank Evaporation in the Journal of Range Management, 26(6), November 1972, pp 404-406. The Dedrick et al. article is incorporated herein by reference in its entirety.

It should be understood that the term “ultraviolet resistant” is intended to refer to a plastic polymer in combination with one or more UV inhibitors (sometimes referred to in the literature as “ultraviolet absorbers”) Non-limiting examples of UV inhibitors include, but are not limited to: Ciba® Tinuvin 123 or Tinuvin 622, Tinuvin-P® (CAS no.: 2440-22-4), Ciba® Tinuvin® XT 833, Ciba® TINUVIN® 494 HALS, BHT, Cyasorb UV 5411®, Ciba® Tinuvin 326, Ciba® TINUVIN 400 Ciba® (triazine ultraviolet absorber), CHIMASORBO 944, Ciba® Tinuvin 1577 FF, and Ciba Tinuvin 327, and any suitable light stabilizers. UV inhibitors in combination with plastic are described, for example, in U.S. Patent Publication Number 20030101872 published Jun. 5, 2003 (filed on Dec. 5, 2001, application Ser. No. 10/007517) to Peel et al. It should be understood that any suitable plastic top layer 220 containing a UV inhibitor may be used in the present invention.

For example, the polymer of the top layer 220 can be blended during the manufacturing process with UV resistant additives such as, but not limited to: hindered amine light stabilizer (HALS) such as the 2,2,4,4-tetramethylpiperidine derivatives such as N,N-bis(2,2,6,6-tetramethyl-4-piperidinyl)-1,6-hexanediamine,bis(-2,2,6,6-tetramethyl-4-piperidinyl) decanedioate, and the reaction product of dimethyl succinate plus 4-hydroxy-2,2,6,6-tetramethyl-1-piperidine-ethanol sold by Ciba-Geigy Corporation under the tradenames Chimassorb 944LD, Tinuvin 770 (described in U.S. Pat. No. 4,396,769 issued Aug. 2, 1983 to Ferreira et al., CAS No.: 52829-07-9), and Tinuvin 622LD, respectively. Such HALS and their use in providing UV resistance properties to, for example, a polyolefin (with suggested weight percent formulations) are described in U.S. Patent Publication Number 20050148720 published on Jul. 7, 2005 to Wen et al. U.S. Patent Publication Number 20050148720 is incorporated herein by reference in its entirety.

The bottom layer 200 can be made of any suitable material that provides buoyancy to the evaporation barrier 100, such as, but not limited to: closed-cell polyolefin foam. Closed-cell polyolefin foam has great resistance to water absorption. For example, the bottom layer 200 can be made of closed-cell EPDM (ethylene propylene diene monomer) sponge rubber. For example, the bottom layer 200 can be closed-cell, chemically cross-linked polyethylene foam. Alternatively, the cross-linking of the polyethylene can be irradiation cross-linked closed-cell polyethylene. Though not preferred, the bottom layer 200 can be made of expanded polystyrene foam (EPS). Polyethylene foam is preferred over EPS because of the ability of polyethylene foam to resist impact damage over EPS. Alternatively, the bottom layer 200 is made of any suitable plastic with discrete airtight air pockets therein to provide buoyancy to the evaporation barrier 100 of the present invention.

The bottom layer 200 and/or top layer 220 preferably also block light required for photosynthesis thereby preventing photosynthesis by, for example, algae that might otherwise thrive and grow in the body of water 120. The top 220 and/or bottom layer 200 preferably block light in the wavelength bands of 350-500 nm and 600-700 nm to prevent photosynthesis. Blocking sunlight can be achieved, for example, as described in U.S. Patent Publication No. 20050125887, filed Jun. 16, 2005, and published to Michael Allen Taylor. U.S. Patent Publication No. 20050125887 is incorporated herein by reference in its entirety.

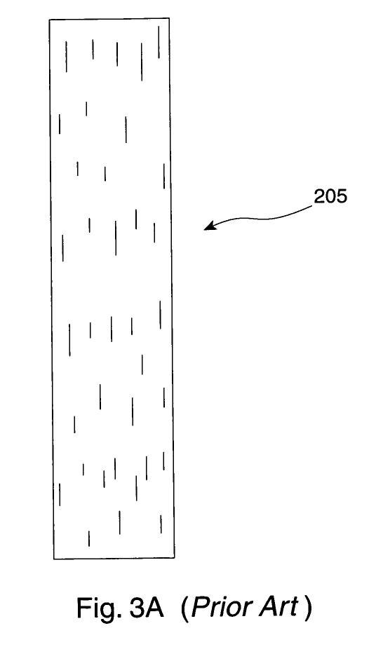

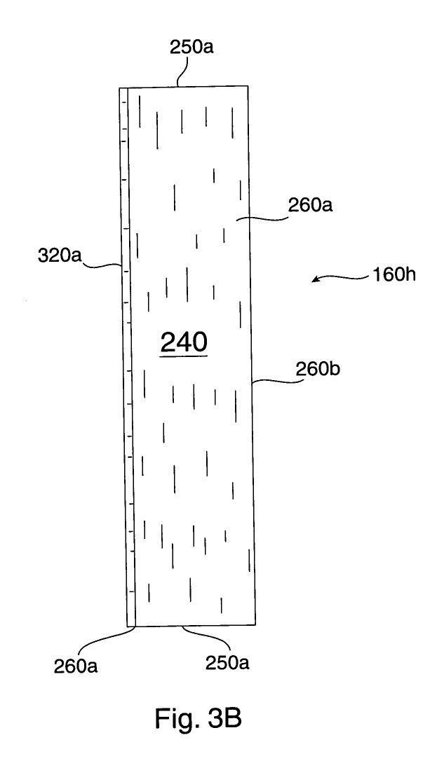

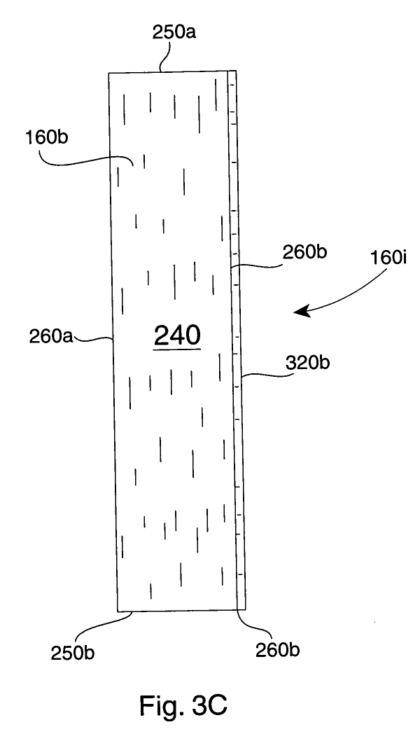

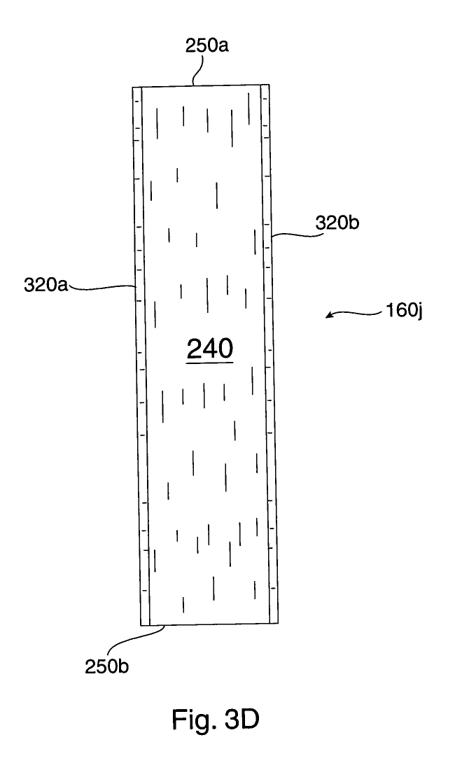

Referring to FIGS. 2A through 3C which show end views of evaporation sheets 160, the water resistant bottom layer 200 defines lower surface 240 of sheet 160, and first and second opposite edges 260a and 260b, respectively. The UV resistant top layer 220 defines an upper surface 300 (shown, e.g., in FIG. 2B) of sheet 160. The top layer 220 overlaps at least part of one edge 260 of the bottom layer 200 thereby defining an elongated overlapping section 320 of UV resistant top layer 220.

The exact nature of the overlap can vary. For example, in FIG. 2B, the sheet 160 (represented by alpha-numeric label “160h”) has a single overlap section 320a that overlaps edge 260a. In FIG. 2C, the sheet (represented by alpha-numeric label “160i”) has a single overlap section 320b that overlaps edge 260b. In FIG. 2D, the sheet 160 (represented by alpha-numeric label “160j”) has a two overlapping sections 320a and 320b that overlap first and second opposite edges 260a and 260b, respectively.

As noted previously, sheets 160 with single or two overlapping sections can be affixed to an adjacent sheet that lacks an overlap. FIG. 1B shows a non-limiting embodiment in which prior art sheet 205 (represented by sheets 205a, 205b, and 205c) completely lacks an overlap, but can nevertheless be used in combination with the sheets 160 having at least one overlap section 320.

The overlapping section 320 is fastened to top surface 300 of the next adjacent sheet 160b. The form of fastening can vary. For example, an overlap section 320 can be joined to the top layer 220 of an adjacent sheet 160 by applying an adhesive compound between the overlap section 320 and the top layer 220 of an adjacent sheet 160 of the present invention or a prior art sheet 205. Any type of suitable adhesive can be used to fasten each overlap section 320 to the top layer 220 of an adjacent sheet 160 or 205. For example, a contact cement based adhesive can be used to fasten an overlap section 320 to the top layer 220 (i.e., top surface 300) of an adjacent sheet 160 or 205.

The overlap section 320 can be mechanically fastened, e.g., an overlap section 320 can be stapled to the top layer 220 of an adjacent sheet 160.

Alternatively, an overlap section 320 can be heat welded to the top layer 220 of an adjacent sheet 160. For example, two sheets 160 can be heat welded together by heat welding an overlap section 320 to the top layer 220 of an adjacent sheet 160. Any suitable heat-welding device can be used such as a UNIMAT welding machine, which can be used to weld overlaps of 20mm to 40mm to join adjacent sheets 160. The UNIMAT machine is used to unite each overlap section 320 with the top layer 220 of an adjacent sheet 160. Blow heat guns can also be used such as, but not limited to: a Dura blow heat gun. UNIMAT welding machines are available from numerous suppliers, such as, but not limited to: AAA American Plastic Welding Technologies L.L.P., 119 North Hewitt Drive, Suite 101—Hewitt, Tex. 76643 Tel.: (254) 666-0551—Fax: (254) 666-0588.

It should be understood that any combination of mechanical fastening, chemical fastening using adhesive, and heat welding, alone or in combination, might be used to fasten an overlap section 320 to the top layer 220 of an adjacent sheet 160 or sheet type 205.

Referring to FIG. 1B. FIG. 1B shows a cross-section view of the evaporation barrier 100 along line A-A′ (see FIG. 1A). The evaporation barrier 100 comprises a plurality of sheets 160 represented by alphanumeric labels 205a, 160a, 205b, 205c. The sheets 160b and 160b each have two overlap sections 320a and 320b, and three sheets 205a, 205b, and 205c lack an overlapping section and represent prior art sheets. The overlapping sections 320a and 320b of sheet 160a are affixed to the top layer 220 of sheets 205a and 205b, respectively. Likewise, the overlapping sections 320a and 320b of sheet 160b are affixed to the top layer 220 of sheets 205b and 205c, respectively. The sheets 205a and 205c are the opposite end sheets of evaporation barrier 100. For convenience only, the arrangement of the plurality of sheets 160, represented by alphanumeric labels 160a through 160e, is referred to herein as a “stepping stone arrangement”. It should be understood that the number of sheets 160 and prior art sheets 205 might vary without detracting from the invention. It should also be understood that the evaporation barrier might comprise of a mix of sheets 160 and prior art sheets 205. It should also be understood that the evaporation barrier might comprise of only sheets 160 of the present invention.

Referring to FIG. 1C. FIG. 1C shows a cross-section view of a further embodiment of the evaporation barrier 100 according to the present invention. More specifically, the evaporation barrier 100 comprises a plurality of sheets 160 represented by alphanumeric labels 160c through 160g. The sheets 160c through 160g each have a single overlapping section 320. For convenience only, the arrangement of the plurality of sheets 160, represented by alphanumeric labels 160c through 160g, can be referred to herein as a “stepped arrangement”. It should be understood that the number of sheets 160 can vary. It should be further understood that the sheets 160 can be arranged in a variety of ways and the arrangements shown in FIGS. 1B and 1C are not intended to limit the scope of the claimed invention in any way.

The evaporation barrier 100 of the present invention is a great improvement over the evaporation reducing covers described by Dedrick and Dedrick et al. More specifically, the overlapping top layer 220 avoids the problem of having to overlap the bottom layer. In the Dedrick type covers, sheets of rubber foam are overlapped thus causing a greater amount of sheeting to be used compared to the present invention. Overlapping the bottom layer would cause ridges on the top of the evaporation barrier that would attract wear and matter during periods of high wind and in turn cause additional stress on the overlapped sections, which may deteriorate and lift up causing the Dedrick type cover to lift and suffer further damage in high winds. The overlapping top layer 220 of the present invention are non-obvious and avoids the inherent problems found in the Dedrick and Dedrick et al. covers.

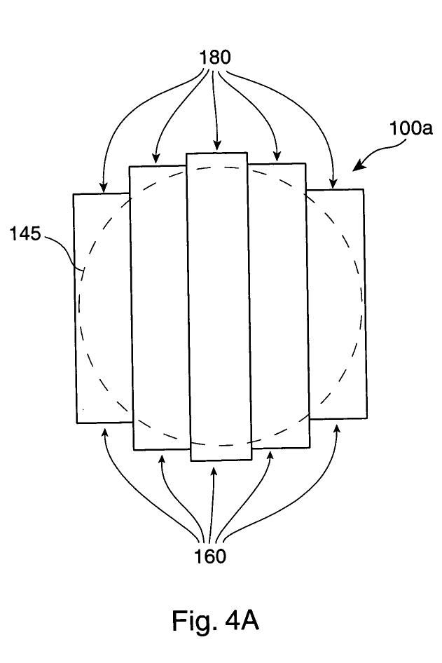

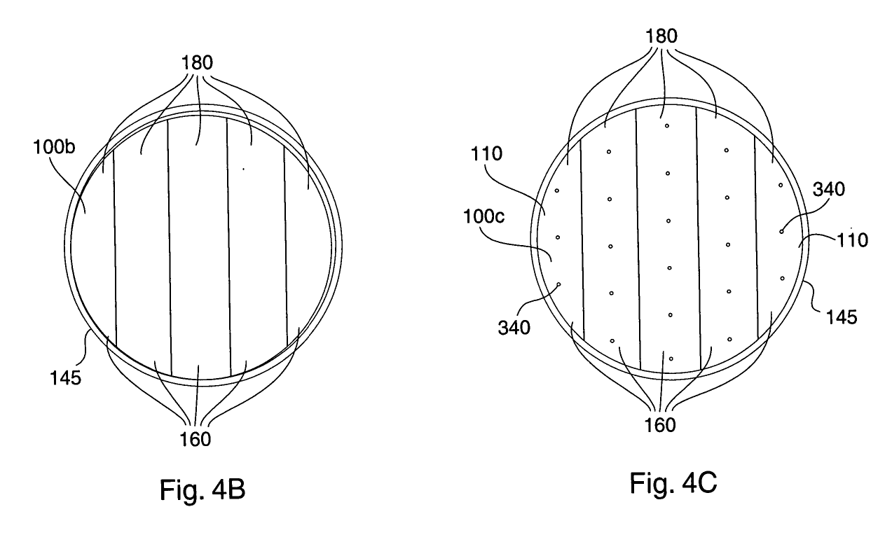

FIG. 4A is a top view of an untrimmed, assembled evaporation barrier 100 (represented by alphanumeric label lOa) according to the present invention. The lengths of the sheets 160 have been selected to overlap the rim 145 (shown in dashed lines) of a water storage tank 140 (shown in FIG. 1A) The opposite ends of each sheet 160 are trimmed or cut to the extent that the evaporation barrier 10Db can be fitted just inside the rim 145.

FIG. 4B is a top view of the evaporation barrier of FIG. 4A after cutting (represented by alphanumeric label “100b”). One non-limiting method of cutting is described in an article by Allen R. Dedrick (“the Dedrick article”) in Foam Rubber Covers For Controlling Water Storage Tank Evaporation, published by the College of Agriculture, Cooperative Extension Service, Miscellaneous Report #2, University of Arizona; the Dedrick article is incorporated herein by reference in its entirety. It should be understood that water storage tanks (which can take various forms such as that of a swimming pool) can vary in their overall shape. Thus, it should be understood that the opposite ends of the sheets 160 can be trimmed or cut to correspond with the outline shape of any water storage tank. In the event that a water storage tank is of very unusual shape, then more than one evaporation barrier 100 can be sized, trimmed and fitted to such a water tank for reducing evaporation of water contained therein.

FIG. 4C is a top view of an evaporation barrier 100 (represented by alphanumeric label “100c”) with optional apertures 340 drilled through various sheets 160. The optional apertures 340 function as bailing holes allowing a tighter fit between the edges of a water storage tank and the outer edge 110 of the evaporation barrier 100. The apertures 340 allow the evaporation barrier 100 to self-bail in the event of, for example, heavy rain falling onto the top surface 300 of the evaporation barrier 100. The optional apertures 340 can be any suitable diameter such as, but not limited to, ½ inch to 2 inches in diameter. Obviously, the greater the number and diameter of the optional apertures 340, the greater the water loss through the apertures 340 during dry hot days.

The thickness of either layer 200 and 220 can vary. In one non-limiting embodiment, the thickness of the bottom layer 200 is between about 3/16th inch and about 1 inch, and the top layer 220 is between about 0.001 inch and 0.3 inch in thickness. The overlap section(s) 320 can have different widths, for example, between about 0.5 inch and about 10 inch in width (represented by the label “d₂” in, e.g., FIG. 2B).

The overall width of each sheet 160 (represented by the label “d₁” in, e.g., FIGS. 2B and 2C) can vary between about one foot and about 6 feet in width. Preferably, the sheets 160 are about 2 feet to about 6 feet in width, and more preferably between about 3 feet and about 5 feet in width. Most preferably, sheet 160 is between about 3.5 feet and 4.5 feet in width. Sheet 160 may be about 4 feet (48 inches) in width.

In one non-limiting embodiment, the bottom layer is a sheet of about ¼ inch thickness and made of closed-cell, low density synthetic rubber such as expanded rubber in which closed-cells act like individual balloons giving the rubber sheet low water absorption and high buoyancy properties, such rubber sheets are readily available in roll-stock form up to five feet in width, e.g., four feet wide roll-stock is available from Voltek LLC, MA, 01843.

In another embodiment, the evaporation barrier sheet 160 includes a top layer 220 that overlaps a first opposite edge 260a to provide an overlap section 320a (see FIG. 2B). In this embodiment, the top layer 220 is between about 0.001 inch and 0.3 inch in thickness, and the overlap section 320a is between about 0.5 inch and about 10 inches in width, and the bottom layer is between about 3/16 inch and about 1 inch in thickness. Alternatively, the top layer is between about 0.005 inch and 0.05 inch in thickness.

In another embodiment, the evaporation barrier sheet 160 includes a top layer 220 that overlaps a first opposite edge 260b to provide an overlap section 320b (see FIG. 2C). In this embodiment, the top layer 220 is between about 0.001 inch and 0.3 inch in thickness, and the overlap section 320a is between about 0.5 inch and about 10 inches in width, and the bottom layer is between about 3/16 inch and about 1 inch in thickness. Alternatively, the top layer is between about 0.005 inch and 0.05 inch in thickness. Thus, the evaporation barrier sheet 100 includes at least one overlap section 320.

In one embodiment, the evaporation barrier sheet 160 has a top layer 220 between about 0.005 inch and 0.05 inch in thickness, and a bottom layer 200 that comprises water resistant closed-cell polyolefin foam between about 3/16 inch and about 1 inch in thickness.

In one embodiment, the evaporation barrier sheet 160 has a top layer 220 about 0.005 inch in thickness and made of ultraviolet resistant polyethylene. The bottom layer 200 comprises water resistant closed-cell polyolefin foam, wherein said bottom layer is between about 3/16 inch and about 1 inch in thickness.

In one embodiment, the evaporation barrier sheet 160 has a top layer 220 of about 0.005 inch in thickness and made of ultraviolet resistant polyethylene. The bottom layer 200 comprises water resistant closed-cell polyolefin foam between about 3/16 inch and about ¼ inch in thickness.

In one embodiment, the evaporation barrier sheet 160 has a bottom layer between about 3/16 inch and about ¼ inch in thickness and is made of ethylene propylene diene monomer (EPDM) foam rubber.

In one embodiment, the evaporation barrier sheet 160 comprises at least one aperture 340 that functions as a bail hole.

In another embodiment, the evaporation barrier 100 comprises: a plurality of generally elongated sheets 160 arranged in adjacent rows (e.g., see FIG. 4C). At least one one sheet 160 comprises a water resistant bottom layer 200 having opposite ends 250a and 250b and first and second opposite edges 260a and 260b, and a 220 UV resistant top layer attached atop of the bottom layer 200. The top layer 220 overlaps at least part of one edge 260a and/or 260b of the bottom layer 200 thereby defining an elongated overlap section 320. The overlap section 320 is fastened to the top layer 220 of adjacent sheets as shown in FIGS. 1B and 1C. For example, sheets 160 and 205 can be arranged in a stepping stone arrangement (see FIG. 1B), and sheets 160 can be arranged in a stepped arrangement (see FIG. 1C). Thus, sheets 160 of the present invention can be used alone or in combination with prior art sheets 250.

The overlapping section 320 (i.e., 320a and/or 320b) can be fastened to the top layer 220 of an adjacent sheet 160 in any number of suitable ways including, but not limited to: mechanical fastening (such as, but not limited to, stapling), by heat welding, and/or by application of adhesive between the overlap section 320 and the top layer 220 of an adjacent sheet 160.

In still another embodiment, the bottom layer is about 4 inch in thickness and made of a closed cell EPDM (ethylene propylene diene monomer) sponge rubber, and the top layer 220 is between about 0.5 mm and 3 mm in thickness and made of ultraviolet resistant polyethylene. Roll lengths of bottom layer 200 in combination with top layer 220 are available, for example, from Voltek LLC (a division of Sekisui America Corporation) located at 100 Shepard Street, Lawrence, Mass. 01843 (TEL: 978-685-2557, FAX: 978-685-9861). However, roll lengths with overlaps as described are claimed herein.

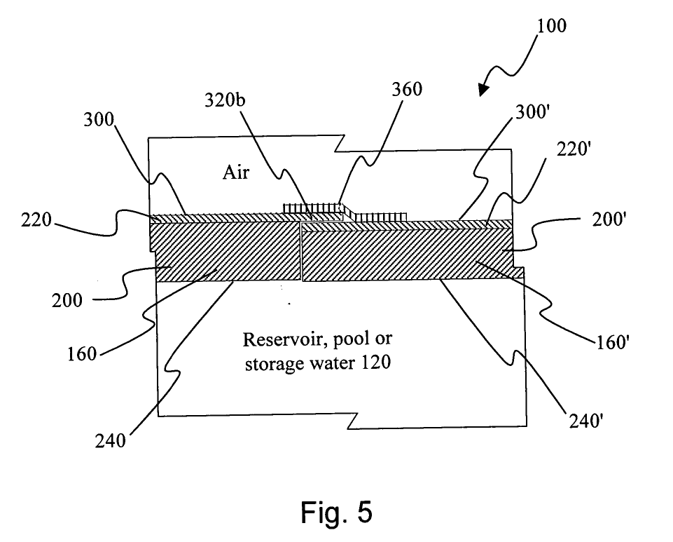

In a further embodiment, a third layer 360 is used to cover at least one overlap section 320 as shown in FIG. 5. More specifically, the third layer 360 serves to protect the joint between the overlap section 320 of one sheet 160 and the top layer 220 of an adjoining sheet 160.

It is to be understood that the present invention is not limited to the embodiments described above, but encompasses any and all embodiments within the scope of the following claims.

We claim:

1. An evaporation barrier sheet, comprising:
a water resistant bottom layer having first and second opposite ends, and first and second opposite edges; and
a UV resistant top layer attached atop of said bottom layer, wherein said top layer overlaps at least part of at least one edge of said bottom layer.

2. The evaporation barrier sheet according to claim 1, wherein said top layer is between about 0.005 inch and 0.3 inch in thickness, wherein said top layer overlaps said first and second opposite edges to provide first and second overlap sections, wherein said overlap sections are between about 0.5 inch and about 10 inches in width, and wherein said bottom layer is between about 3/16 inch and about 1 inch in thickness.

3. The evaporation barrier sheet according to claim 1, wherein said top layer overlaps said first opposite edge to provide an overlap section, wherein said top layer is between about 0.005 inch and 0.3 inch in thickness, wherein said overlap section is between about 0.5 inch and about 10 inches in width, and wherein said bottom layer is between about 3/16 inch and about 1 inch in thickness.

4. The evaporation barrier sheet according to claim 1, wherein said top layer overlaps said second opposite edge to provide an overlap section, wherein said top layer is between about 0.005 inch and 0.3 inch in thickness, wherein said overlap section is between about 0.5 inch and about 10 inch in width, and wherein said bottom layer is between about 3/16 inch and about 1 inch in thickness.

5. The evaporation barrier sheet according to claim 1, wherein said at least one overlap is about 1 inch in width, wherein said top layer is between about 0.005 inch and 0.05 inch in thickness, and wherein said bottom layer is between about 3/16 inch and about 1 inch in thickness.

6. The evaporation barrier sheet according to claim 1, wherein said top layer is between about 0.005 inch and 0.05 inch in thickness, and wherein said bottom layer comprises water resistant closed-cell polyolefin foam, wherein said bottom layer is between about 3/16 inch and about 1 inch in thickness.

7. The evaporation barrier sheet according to claim 1, wherein said top layer is about 0.005 inch in thickness and made of ultraviolet resistant polyethylene, and wherein said bottom layer comprises water resistant closed-cell polyolefin foam, wherein said bottom layer is between about 3/16 inch and about 1 inch in thickness.

8. The evaporation barrier sheet according to claim 1, wherein said top layer is about 0.005 inch in thickness and made of ultraviolet resistant polyethylene, and wherein said bottom layer comprises water resistant closed-cell polyolefin foam, wherein said bottom layer is between about 3/16 inch and about 4 inch in thickness.

9. The evaporation barrier sheet according to claim 1, wherein said bottom layer is between about 3/16 inch and about 4 inch in thickness and made of ethylene propylene diene monomer (EPDM) foam rubber.

10. The evaporation barrier sheet according to claim 1, wherein said sheet comprises at least one aperture that functions as a bail hole.

11. An evaporation barrier 100 for covering a body of water, comprising:
a plurality of generally elongated sheets, wherein at least one sheet comprises:
a water resistant bottom layer having opposite ends and first and second opposite edges, and
a UV resistant top layer attached atop of said bottom layer, wherein said top layer overlaps at least part of one edge of said bottom layer thereby defining an elongated overlap section of said UV resistant top layer,
wherein said overlap section is fastened to the top layer of an adjacent sheet.

12. The evaporation barrier according to claim 11, wherein said plurality of generally elongated sheets are arranged in a stepping stone arrangement.

13. The evaporation barrier according to claim 11, wherein said plurality of generally elongated sheets are arranged in a stepped arrangement.

14. The evaporation barrier according to claim 11, wherein said at least one overlapping top layer is mechanically fastened to the top layer of an adjacent sheet.

15. The evaporation barrier according to claim 11, wherein said overlap section is fastened by heat welding to the top layer of an adjacent sheet.

16. The evaporation barrier according to claim 11, wherein said at least one overlapping top layer is fastened by application of adhesive between the overlap section and the top layer of an adjacent sheet.

17. The evaporation barrier according to claim 11, wherein said evaporation barrier further comprises a plurality of apertures that function as bail holes.

18. The evaporation barrier according to claim 11, wherein said evaporation barrier further comprises a third layer 360.

19. The evaporation barrier according to claim 11, wherein said top layer is between about 0.005 inch and 0.05 inch in thickness, and wherein said bottom layer is between about 3/16 inch and about 1 inch in thickness.

20. An evaporation barrier for covering a body of water, comprising:
a plurality of generally elongated sheets 160 and 205, said sheets are arranged in adjacent rows, wherein at least one sheet 160 comprises:
a water resistant bottom layer 200 having opposite ends and first and second opposite edges and made of cross-linked closed-cell polyolefin foam sheet, wherein said bottom layer is between about 3/16 inch and about ¼ inch in thickness, and
a UV resistant top layer 220 attached atop of said bottom layer, wherein said top layer is between about 0.005 inch and 0.05 inch in thickness,
wherein said top layer overlaps at least part of one edge of said bottom layer thereby defining an elongated overlap section 320 about 1 inch in width, and
wherein said overlap section 320 is heat welded to the top layer 220 of an adjacent sheet.
